(19) United States
(12) Patent Application Publication
(10) Pub. No.: US 2016/0162987 A1
(43) Pub. Date: Jun. 9, 2016

(54) SYSTEM AND METHOD FOR FACILITATING MULTI-YEAR REGISTRATION OF A MOTOR VEHICLE

(71) Applicant: Mehdi Roufougar, Carlsbad, CA (US)

(72) Inventor: Mehdi Roufougar, Carlsbad, CA (US)

(21) Appl. No.: 15/042,458

(22) Filed: Feb. 12, 2016

Related U.S. Application Data
(63) Continuation of application No. 13/276,796, filed on Oct. 19, 2011, now abandoned.

(51) Int. Cl. G06Q 40/02; G06Q 20/22

(52) U.S. Cl. CPC G06Q 40/02; G06Q 20/22

(57) ABSTRACT

A system and method for facilitating in year registration of a vehicle via financing is provided. The method comprises: determining multi-year registration fee amounts over a term of the financing of the vehicle; obtaining first periodic loan payment amounts for a first case of financing by including the multi-year registration fee amounts in a principal and second periodic loan payment amounts for a second case of financing by including a first-year registration fee amount in the principal; and displaying comparative data at least including the first periodic loan payment amounts versus the second periodic loan payment amounts and the total of the multi-year registration fee amounts versus the first-year registration fee amount.

### CROSS-REFERENCE TO RELATED APPLICATION

This is a continuation application of U.S. patent application Ser. No. 13/276,796, filed on Oct. 19, 2011.

### BACKGROUND

Motor vehicles must be registered with a government authority for use on public roads and streets, The purpose of such registrations is to establish clear ownership and to tax vehicle owners to pay for repairs and maintenance of public roads and streets. While almost all vehicles are uniquely identified by a vehicle identification number (VIN), only registered vehicles display a vehicle registration plate and carry a vehicle registration certificate. Vehicle registration in the United States is managed by each states motor vehicle agency or an equivalent state governmental agency. Vehicles that are no used on public roads, such as tractors or vehicles, the use of which is limited to private property, are not always required to be registered. The average cost of license and registration in the United States is currently about $300 for the first year, and the amount decreases in subsequent years. The amount of the registration fee is usually related to the purchase price of the vehicle. In most states in the U.S., a liability insurance policy that meets the states auto insurance requirements must be obtained before a vehicle can be registered.

A motor vehicle may be purchased with cash. However, typically, a consumer may purchase a motor vehicle using a financial instrument commonly referred to as a Retail Installment Sale Contract, wherein an agreed upon total amount, i.e., the principal, is financed over a period of time, typically 48 or 60 months, whereupon the consumer makes periodic loan payments, e.g., monthly payment, to a lending organization such as a bank, credit union, lending arm of a car manufacturer, or other financial institution, The total amount financed conventionally includes the agreed-upon selling price of the vehicle including options, plus certain other fees and taxes such as a title fee, a license plate fee, a registration fee, a tire fee, an acquisition fee, a delivery charge, short term liability insurance, and sales taxes, for example. The total amount may be reduced by a trade-in allowance, a down payment, rebates, and credits of various kinds, for example. Liability insurance may be included in the purchase transaction or may be paid by the car dealer for a few days or typically about one week, after the purchase until the purchaser acquires his/her own insurance policy.

Typically, a new or used vehicle dealer, i.e., a commercially licensed seller, makes all the financial and registration arrangements so that a purchaser needs only to pay an initial payment, usually in the form of a check, cash, credit card, or other financial means, and is then able to drive away in the purchased vehicle. Alternately, the purchaser may arrange his/her own financing with a hank, credit union or other financial institution. In this case the financial arrangements are made prior to contracting with the car dealer. In either case, it is the dealer who specifies the total amount to be financed, and this generally includes the vehicle registration fee.

It is also a common practice for a consumer to lease a motor vehicle using a financial instrument commonly referred to as a Motor Vehicle Lease Agreement, by which lease payments are paid periodically, e.g., monthly. Whether the deal is an outright purchase or a lease, a vehicle registration is required and the registration fee is paid for the first year of operation of the motor vehicle. The registration fee is normally included as part of the financing or leasing agreement. Thereafter, the purchaser or lessee of the vehicle is obliged to pay the annual registration fees as long as the vehicle is owned and operated on public roads. Upon resale of the vehicle, the new owner is obliged to pay the annual registration fees.

### BRIEF DESCRIPTION OF THE DRAWING

FIG. 1 illustrates an example system for facilitating multi-year registration of a motor vehicle via financing, according, to an embodiment.

FIG. 2 illustrates an example process for facilitating multi-year registration of a motor vehicle via financing, according to an embodiment, at the point of sale of the vehicle when the financing contract is to be agreed upon.

### DETAILED DESCRIPTION

As explained above, the conventional way of financing a purchase or lease of a vehicle includes the first year registration fee, whereby the purchaser or lessee of the vehicle, collectively called a buyer herein, separately pay the subsequent year annual registration fees to each state's motor vehicle agency or an equivalent state governmental agency, collectively called Department of Motor Vehicles (DMV) herein. In view of such conventional financing, this document describes a system and method for facilitating a new way of financing a purchase or lease including multi-year registration of a motor vehicle. As explained in the following, the multi-year registration may potentially benefit both the buyer and the state. In the present system and method, a provision is made for a buyer to have an option of including the amount of vehicle registration fees for the entire term of the financing contract and roll them into periodic loan payments.

Table 1 below illustrates an example of comparing two scenarios: a conventional scenario in which the sale price of $20,000 plus the first year registration fee of $240 are financed; and an alternative scenario in which the sale price of $20,000 plus the registration fees $982.82 over the full term (5 years in this example) are financed. As mentioned earlier, the sale price may include: a selling price of the vehicle itself and one or more of a title fee, a license plate fee, a tire fee, an acquisition fee, a delivery charge, short term liability insurance, sales taxes, and other fees and taxes, The total amount may be reduced by a trade-in allowance, a down payment, rebates, and credits of various kinds, for example. Namely, the sale price herein is defined to include all required fees, taxes and deductions in addition to the selling price of the vehicle itself, except for the registration fee. Liability insurance may be included in the financing or may be paid by the car dealer, called a seller herein, for a few days or typically about one week, after the purchase until the purchaser acquires his/her own insurance policy. Thus, the principal herein is the sum of the sale price, which includes all fees, taxes, deductions, etc. associated with the vehicle sale, and the registration fee amount. An interest rate of 3% is assumed in the present example. Table 1 shows that the buyer pays the monthly loan payment that is only $13.34 ($377.03-$363.69) higher in the scenario where the full-term registration is included in the principal than in the conventional scenario. On the other hand, in the first year, the state gets the 5-year worth of registration fees of $982.82, instead of the first year registration fee of only $240, ahead of time as the state revenue. (The above two notable features are emphasized in bold in Table 1.)

TABLE 1

| | Sale + 1 year | Sale + 5 year |
|---|---|---|
| Item | Registration | Registration |
| Principal Financed | $20,240 | $20,982.82 |
| Term (5 years) | 60 months | 60 months |
| Interest Rate | 3% | 3% |
| Monthly Payment | $363.69 | $377.03 |
| Registration | $240 | $982.82 |

The above two financing scenarios are analyzed differently as below for the State of California as an example. California franchise car dealerships are selling an average of 1.6 million new vehicles a year. Approximately 10% of the sale, which is about 160,000 vehicles, are sold on the cash basis; about 20% or 320,000 vehicles are leased; and the other 1.1 million new vehicles are financed by banks, credit unions and other financial institutions. The average fee to register a new vehicle in the State of California is about $400. Table 2 illustrates an example projection of the state's revenue from motor vehicle registration fees over 5 years. A constant sale of 1.1 million new vehicles per year is assumed. in the conventional scenario wherein only the first year registration fee is included in the financing, the state gets $440 M via vehicle registrations in the first year. On the other hand, in the alternative scenario wherein the registration fees over the full term (5 years in this example) are financed, the state gets $ 1.48 B in the first year. That is, with the advance payment of the forthcoming registration fees for the years 2017, 2018, 2019 and 2020, the state can get ahead with $1.04 B ($1.48 B-$440 M) cash on hand. The state may use the same procedure for lessees who lease vehicles, and get ahead with another $630 M. And if the state would do the same with used vehicles, motorcycles, recreation vehicles and other type of vehicles, this revenue would easily grow close to $2.0 B by the end of 2016. These earnings can be realized every year, thereby continuously helping reduce the state budget deficit.

TABLE 2

| | | |
|---|---|---|
| | Registration | State Revenue via Registration |
| Year | Fee | of 1.1 M Vehicles |

| | | | |
|---|---|---|---|
| 2016 | $400 | $440 | M |
| 2017 | $320 | $352 | M |
| 2018 | $256 | $281.6 | M |
| 2019 | $205 | $225.5 | M |
| 2020 | $164 | $180.4 | M |

| | | |
|---|---|---|
| Total = | $1.48 | B |

One aspect of the above alternative financing scheme is that vehicle registration fees that are, or will come, due during the term of a financed purchase or lease are included in the financing or lease arrangement, collectively called financing herein. One can conceive various benefits associated with prepaying vehicle registration fees ahead of time For example, as shown in Table 1, the buyer pays the monthly loan payment that is only $13.34 higher in the scenario where the full-term registration is included in the principal than in the conventional scenario where only the first-year registration is included in the principal, while appreciating the fact that he/she does not have to worry about payments of registration fees in the upcoming years. In another example, since the buyer does not have to pay vehicle registration fees annually during the financing or lease term, collectively called a financing term, he she does not have to deal with the state office through which such payments are made, while the state is saving money on staff salaries, administrative supplies, utilities, and so on. In yet another example, a resale of the vehicle during the financing term will include pre-paid vehicle registration fees over the remaining of the term, which may appear attractive to a prospective next buyer. In yet another example, the state office will receive a significantly increased revenue flow at the point of vehicle purchase or leasing instead of smaller payments spread over the financing term. In yet another example, banks, credit unions and other financial institutions tendering to the financing of the vehicle will receive increased financing fee revenue over the term of the contract due to a larger principal amount. It is also noteworthy that sometimes car manufacturers offer zero or very low interest rates for promotion purposes, which makes buyers feel even more comfortable in getting such financing.

To facilitate multi-year registration of a motor vehicle via financing, a system and method are configured, including computers operated by mutually independent entities, computer programs with instructions to perform various operations, and data shared between two or more entities. The present system and method provides a purchaser or lessee, collectively called a buyer herein, with an option of financing all annual vehicle registration fees that will come due during the term of the vehicle purchase or lease contract, collectively called a financing contract herein. This initially assumes that the buyer will remain the owner-operator of the vehicle during that term. As described earlier in the background section, we see that it is a universal convention whereby the vehicle owner pays the vehicle registration fees to the DMV on an annual basis during the ownership of a vehicle. Typically, the new or used vehicle dealer, collectively called a seller herein, makes all the financial and registration arrangements so that a buyer needs only to pay an initial payment, usually in the form of a check, credit card, cash or other financial means, and is then able to drive away in the vehicle. Alternately, the buyer may arrange his/her own financing with a bank, credit union, lending arm of a manufacturer, or other financial institution. In this case the financial arrangements are made prior to contracting with the seller. In either case, it is the seller who specifies the total amount to be financed, and this may include the vehicle registration fee or fees. The present system and method are configured to facilitate the buyer to get financing including the vehicle registration fees during the entire term.

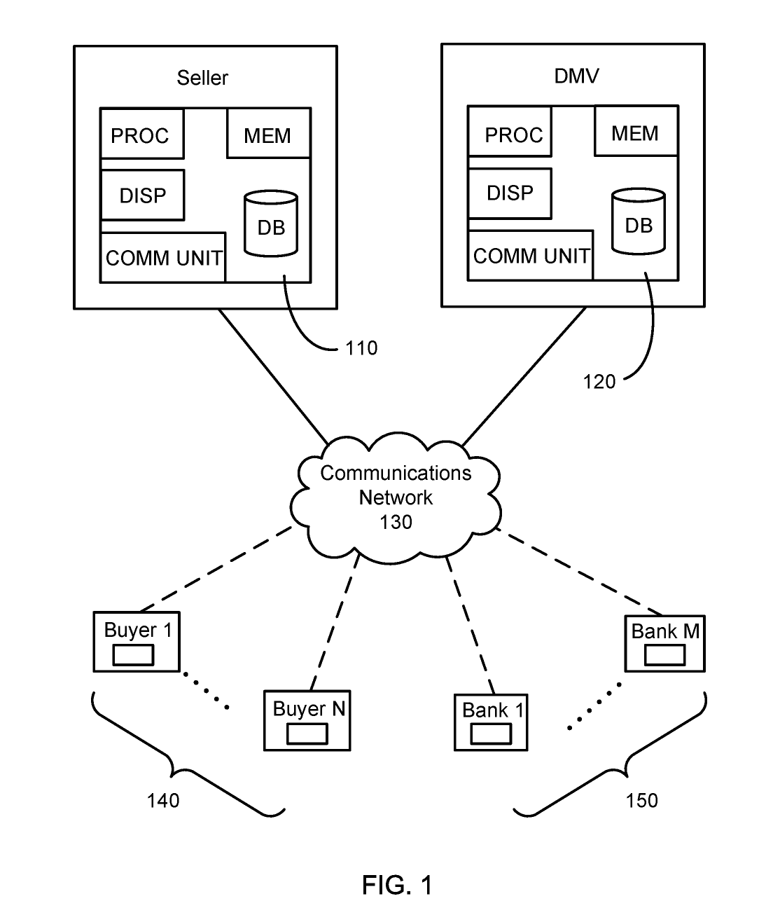

FIG. 1 illustrates an example of the system for facilitating multi-year registration of a motor vehicle via financing, according to an embodiment. A first computer 110 is associated with the seller and a second computer 120 is associated with the DMV. A ‘computer’ herein is defined as a general digital processing device including a processor, or a CPU, for carrying out various functions and tasks, such as a laptop computer, desktop computer, tablet, smart phone and the like. These computers are interconnected by a communications network 130, which may be the Internet. However, other types of communications network may be contemplated, for example, one or more of a local area network, a wireless network, cloud computing, satellite communications and the like. Each of the computers 110 and 120 includes at least: a processor, a memory, a communication unit, a display with a user interface and a database, respectively labeled PROC, MEM, COMM UNIT, DIPS and DB in FIG. 1. The communication unit allows the computer to interact with other computers coupled to the communications network 130. The memory includes one or more computer programs having computer executable instructions for performing functions and tasks for the associated entity. The processor executes the computer program having computer executable instructions on the memory. The display with a user interface facilitates interactions between the associated entity and the processor. In general, a user input device is further included to allow the associated entity to input and send commands to the processor using a graphical user interface. Information and data are transferred via the communications network 130 among the computers via the respective communication units. The information and data can be stored in the database coupled to the memory of each computer, and retrieved or updated as needed.

The seller may have a plurality of buyers as clients who decide to purchase or lease vehicles from the seller. The computers 140 associated with these buyers, receptively, may optionally be included in the system. The computers 150 associated with financial institutions, respectively, may also optionally be included in the system. Such connections of the computers 140 and 150 via the communications networks 130 may be useful, for example, when the buyer wants to pay periodic payments online to the bank from whom the buyer obtained the financing arrangement or auto loan. However, there are other types of payment instruments for the buyer, such as writing and mailing a check to pay the periodic payments. Further, the bank may use an online transaction, a direct transaction or other method to pay the principal amount of the vehicle financing to the seller on behalf of the buyer, in the case where the buyer took the financing arrangement or auto loan from the bank. As such, the inclusion of any of the buyers' computers 140 and financial institutions' computers 150 in the system is optional; accordingly, the coupling between the communications network 130 and each of these computers 140 and 150 is depicted in dashed line in FIG. 1.

Handling of motor vehicle registration is performed by the seller. The seller makes all the financial and registration arrangements for the buyer. In particular, payment of the registration fee or fees is made by the seller at the point of sale or lease of a vehicle to be registered. Thus, key elements in the present system include the first computer 110 associated with the seller and the second computer 120 associated with the DMV, which are coupled to each other via the communications network 130. In the present system, the memory the first computer 110 includes a first computer program to execute operations for the seller to carry out the sale and registration process; the memory of the second computer 120 includes a second computer program to determine registration fees; the databases of the first computer 110 and the second computer 120 include a set of data transferred between the seller and the DMV. The functions and special features of the computer programs and the type of data utilized are explained in an example process below.

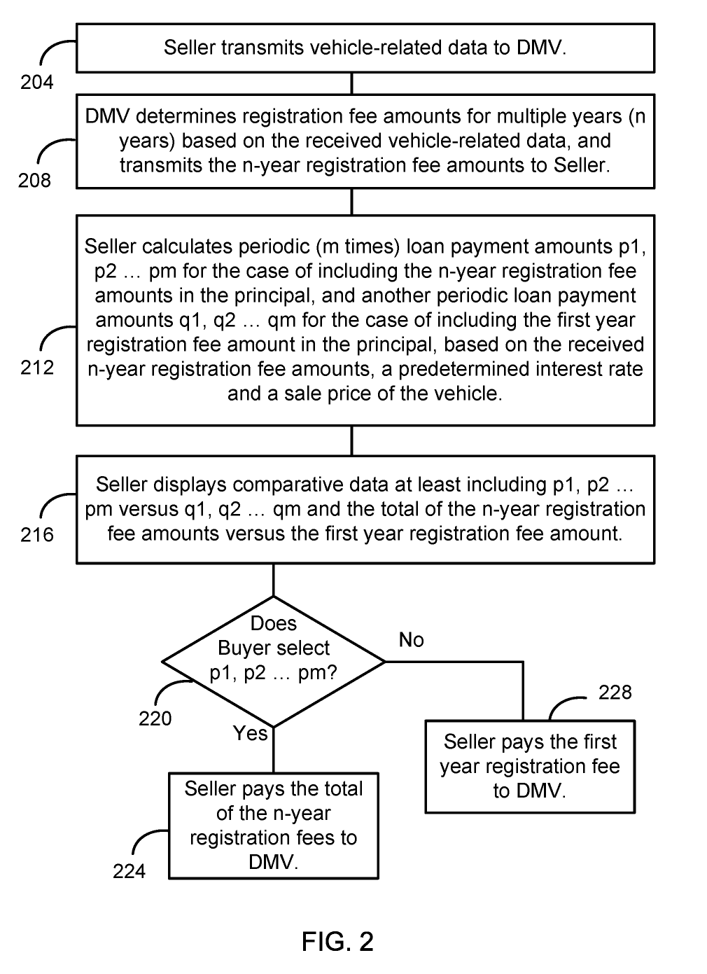

FIG. 2 illustrates an example process for facilitating multi-year registration of a motor vehicle via financing, according to an embodiment, at the point of sale of the vehicle when a. financing contract is to be agreed upon. A similar process can be carried out when the vehicle is leased, and a lease contract, which is also called a financing contract herein, is to be agreed upon. First, in step 204, the seller transmits vehicle-related data to the DMV via the communication unit of the first computer 110 associated with the seller. The vehicle-related data is needed for determining registration fee amounts. The vehicle-related data may be pre-stored in the database of the first computer 110 by inputting the data by the seller via the display with the user interface. Examples of the vehicle-related data include one or more of: a selling or leasing price of the vehicle selected by the buyer, and the type, make, VIN, power type, axle count, and weight of the selected vehicle. The vehicle-related data can be received by the second computer 120 via the communication unit of the second computer 120, and may be stored in the database of the second computer 120. It should be understood that DMV offices are present in all the states, and are relatively independent from each other within a state. They may require different sets of information to determine vehicle registration fees. Therefore, the vehicle-related data may vary from office to office and state to state. However, typical and minimum information for a DMV office to determine registration fee amounts for a vehicle are as follows:
Type: automobile, commercial, motorcycle, trailer, off road, and vessel.
Power source: gasoline, diesel, electric, natural gas, hybrid, propane, flex fuel, and hydrogen.
Make: Ford; Toyota, Honda, Dodge, Chevrolet, etc.
Number of axles: two, three, four, etc.
Weight range: less than 6000 lbs., between 6000 and 10,000 lbs., more than 10,000 lbs.

In step 208, the DMV determines registration fee amounts to be paid for multiple years (n years) based on the received vehicle-related data, and transmits the n-year registration fee amounts to the seller. The number of years, n, corresponds to the length of the term of the financing contract, i.e., the length of the term during which the buyer has to pay off the auto loan. The second computer program installed in the memory of the second computer 120 associated with the DMV is used to determine the registration fee amounts to be paid for multiple years. The second program may be configured to calculate the amounts according to set rules based on the vehicle-related data, or to simply use a lookup table to search for the fee amounts corresponding to the items in the vehicle-related data. Vehicle registration fees are typically paid annually and the fee amount usually drops by a percentage each year as the associated vehicle ages. Currently, it is not a practice to pay for registration of a motor vehicle over the term of financing of the vehicle, which may be up to six years or more. In some states it is not necessary to reregister a vehicle after a certain number of years. When ownership of a vehicle changes (via a resale or gift), the new owner is not usually required to pay to reregister the vehicle until the current registration expires, but this rule varies from state to state. When a vehicle is destroyed, as in an accident, prior paid registration fees are typically not refunded. In view of these and other variations in state rules and practice, the second computer program stored in the memory of the second computer 120 associated with the DMV in each state can be configured to determine the registration fee amounts over multiple years according to the practice and rules of the state.

In step 212, the seller calculates periodic (m times) loan payment amounts, p1, p2 . . . pm for the case of including the n-year registration fee amounts in the principal, and another periodic loan payment amounts, q1, q2 for the case of including the first year registration fee in the principal. The calculation is carried out by using the first computer program stored in the memory of the first computer 110 associated with the seller, Examples of input data for this calculation includes: a period or term of financing (n years) selected by the buyer, typically 4, 5, or 6 years, the received n-year registration fee amounts, a predetermined interest rate, and a sale price of the vehicle. If the buyer decided to take the financing deal from a financial institution of his/her choice, the predetermined interest rate can be obtained from the financial institution and will typically vary depending on the credit rating and commercial history of the buyer. The seller can obtain the information through the communications network 130 if the financial institution is coupled thereto, or through a simple phone call or other communication means. As mentioned earlier with reference to Table 1, the sale price of the vehicle is determined based on: a selling or leasing price of the vehicle itself and one or more of a title fee, a license plate fee, a tire fee, an acquisition fee, a delivery charge, short term liability insurance, sales taxes, and other fees and taxes, as well as a trade-in allowance, a down payment, rebates, credits of various kinds, and other deductions. Namely, the sale price is defined to include all required fees, taxes and deductions, in addition to the selling or leasing price of the vehicle itself, except for the registration fee or fees; and the principal (financed amount) is defined as the sum of the sale price plus the total registration fee amount.

To carry out the calculation, the first computer program may utilize the well-known PMT function found in the Excel spreadsheet, which is widely used in commercial real estate calculations, for example. It is assumed that all periodic payments are equal, that the interest rate is fixed, and that the loan payback is exhausted when the last payment is made. This or other type of publicly known algorithm can be used.

In step 216, the seller displays comparative data at least including p1, p2 . . . pm versus q1, q2 . . . qm and the total of the multi-year registration fee amounts versus the first year registration fee amount. The display can be made using the display with the user interface of the first computer 110 associated with the seller, for the buyer to observe on the display at the seller's site. Alternatively, the display content can be primed out and shown to the buyer. Yet alternatively, the display content can be transmitted through the communications network 130 to the buyer's computer 140, if it is coupled thereto. In any case, as exemplified in Table 1, the comparative data is displayed in a format to clearly show or emphasize that the difference in the periodic loan payment amount is minimal between the case of including the total of the multi-year registration fee amounts in the principal and the other case of including the first year registration fee amount in the principal, whereas the total of the multi-year registration fee amounts is substantially higher than the first year registration fee amount.

In step 220, the buyer decides which financing deal be/she wants to take based on the displayed comparative data. There is a great chance that the buyer may be positively inclined to agree to include the multi-year registration fees in the financing deal because of the clear advantage shown in the displayed comparative data. Furthermore, the registration fees for multi-axle, heavy trucks may be quite expensive, so that once again the buyer may want to spread these fees out over the term of the loan. In both cases, the buyer will readily see that the additional cost of financing multi-year registration fees is not a significant percent of the periodic loan payment.

If the buyer selects to take the financing deal that includes the n-year registration fees in the principal, the process proceeds to step 224, wherein the seller goes ahead and pays the total of the n-year registration fees to the DMV on behalf of the buyer. Subsequently, over the n years, the buyer pays the loan payments p1, p2 . . . and pm, but not the registration fees to the DMV. On the other hand, if the buyer selects to take the financing deal that includes the first year registration fee in the principal, the process proceeds to step 228, wherein the seller pays only the first year registration fee to the DMV on behalf of the buyer. Subsequently, over the n years, the buyer pays the loan payments q1, q2 . . . and qm. In this case, the buyer also pays the second and later year registration fees annually directly to the DMV. In either case, the procedure of registration fee payment can be carried out online through the communications network 130, and the first and second computer programs in the first 110 and second 120 computers associated with the seller and the DMV, respectively, can be configured to cooperatively control the transactions associated with payment of the registration fee or fees from the seller to the DMV.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be exercised from the combination, and the claimed combination may be directed to a subcombination or a variation of a subcombination.

What is claimed is:

1. A system for facilitating multi-year registration of a vehicle via financing, the system comprising:
a first computer associated with a seller of the vehicle, the first computer including a first memory storing a first computer program: and
a second computer associated with a DMV office, the second computer coupled to the first computer through a communications network and including a second memory storing a second computer program,
wherein
the second computer program includes computer executable instructions configured to
determine multi-year registration fee amounts over a term of the financing of a purchase or lease of the vehicle, based on vehicle-related data transmitted from the first computer; and
transmit the multi-year registration fee amounts to the first computer, and the first computer program includes computer executable instructions configured to
obtain a first plurality of periodic loan payment amounts for a first case of financing by including the multi-year registration fee amounts in a principal and to second plurality of periodic loan payment amounts for a second case of financing by including a first-yen registration fee amount in the principal, based on the received multi-year registration fee amounts, a predetermined interest rate and a sale price of the vehicle; and
display comparative data at least including the first plurality of periodic loan payment amounts versus the second plurality of periodic loan payment amounts and the total of the multi-year registration fee amounts versus the first-year registration fee amount, allowing a buyer of the vehicle to select the first case or the second case of financing, based on the comparative data.

2. The system of claim 1, wherein
the first computer program is configured to display the comparative data in a format to emphasize that the difference between each of the first plurality of periodic loan payment amounts and each of the second plurality of periodic loan payment amounts is minimal, whereas the total of the multi-year registration fee amounts is substantially higher than the first year registration fee amount.

3. The system of claim 1, wherein
the first computer program and the second computer program are further configured to control transactions associated with payment of the total of the multi-year registration fee amounts by the seller to the DMV office, if the buyer selects to take the first case of financing.

4. The system of claim 1, wherein
the vehicle-related data includes one or more of: a selling or leasing price of the vehicle, and a type, a make, a VIN, a power source type, an axle count, and a weight of the vehicle.

5. The system of claim 1, wherein
the principal further includes the sale price of the vehicle determined based on: a selling or leasing price of the vehicle, and one or more of a title fee, a license plate fee, a tire fee, an acquisition fee, a delivery charge, short term liability insurance, taxes, a trade-in allowance, a down payment, rebates, and credits.

6. The system of claim 1, wherein
the first computer program includes the computer executable instructions incorporating the PMT function.

7. The system of claim 1, wherein
the second computer program includes the computer executable instructions incorporating state rules and practice of a state where the DMV office is located.

8. A method for facilitating multi-year registration of a vehicle via financing, by using a system comprising: a first computer associated with a seller of the vehicle, the first computer including a first memory storing a first computer program; and a second computer associated with a DMV office, the second computer coupled to the first computer through a communications network and including a second memory storing a second computer program, the method comprising:
determining, by using the second computer program, multi-year registration fee amounts over a term of the financing of a purchase or lease of the vehicle, based on vehicle-related data transmitted front the first computer;
transmitting, by using the second computer program, the multi-year registration fee amounts to the first computer;
obtaining, by using the first computer program, a first plurality of periodic loan payment amounts for a first case of financing by including the multi-year registration fee amounts M a principal and a second plurality of periodic loan payment amounts for a second case of financing by including a first-year registration fee amount in the principal, based on the received multi-year registration fee amounts, a predetermined interest rate and a sale price of the vehicle; and
displaying, by using the first computer program, comparative data at least including the first plurality of periodic loan payment amounts versus the second plurality of periodic loan payment amounts and the total of the multi-year registration fee amounts versus the first-year registration fee amount, allowing a buyer of the vehicle to select the first case or the second case of financing, based on the comparative data.

9. The method of claim 8, wherein
the displaying comprises displaying the comparative data in a format to emphasize that the difference between each of the first plurality of periodic loan payment amounts and each of the second plurality of periodic loan payment amounts is minimal, whereas the total of the multi-year registration fee amounts is substantially higher than the first year registration fee amount.

10. The method of claim 8, the method further comprising:
controlling, by using the first computer program and the second computer program, transactions associated with payment of the total of the multi-year registration fee amounts by the seller to the DMV office, if the buyer selects to take the first case of financing.

11. The method of claim 8, wherein
the vehicle-related data includes one or more of: a selling or leasing price of the vehicle, and a type, a make, a VIN, a power source type, an axle count, and a weight of the vehicle.

12. The method of claim 8, wherein p1 the principal further includes the sale price of the vehicle determined based on: a selling or leasing price of the vehicle, and one or more of a title fee, a license plate fee, a tire fee, an acquisition fee, a delivery charge, short term liability insurance, taxes, a trade-in allowance, a down payment, rebates, and credits.

13. The method of claim 8, wherein
the obtaining comprises obtaining the lust plurality of periodic loan payment amount and the second plurality of periodic loan payment amounts by incorporating the PMT function with the first computer program.

14. The method of claim 8, wherein
the determining comprises determining the multi-year registration fee amounts by incorporating state rules and practice of a state where the DMV office is located with the second computer program.
